(19) United States
(12) Patent Application Publication
(10) Pub. No.: US 2007/0019265 A1
(43) Pub. Date: Jan. 25, 2007

(54) Laser scanning unit and image forming apparatus having the same

(75) Inventors: Duek-chun Park, Suwon-si (KR); Chul-hyun Park, Suwon-si (KR); Tae-kyoung Lee, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics, Co., Ltd., Suwon-si (KR)

(21) Appl. No.: 11/483,660

(22) Filed: Jul. 11, 2006

(30) Foreign Application Priority Data
Jul. 20, 2005 (KR) 2005-65672

(51) Int. Cl. G02B 5/32

(52) U.S. Cl. 359/18

(57) ABSTRACT

A laser scanning unit and an image forming apparatus employing the laser scanning unit including a light source generating light; a polygon mirror that includes a plurality of reflection mirrors with a polygonal horizontal cross-section, and the polygon mirror rotates to scan the beam from the light source in a main scanning direction, and a light interruption member swinging between a shut position and an open position to selectively block or clear the light path to the polygon mirror according to whether the polygon mirror is operated or not. The light interruption member is swung to the opening position by air pressure generated during an operation of the polygon mirror and returns to the shut position by a restoration force when the polygon mirror stops rotating. The laser scanning unit and the image forming apparatus employing the laser scanning unit include a laser beam interruption structure to prevent body damage of the operators during maintenance and repair and to reduce additional manufacturing costs and installation space.

### CROSS-REFERENCE TO RELATED APPLICATIONS

This application claims the priority of Korean Patent Application No. 10-2005-0065672, filed on Jul. 20, 2005, in the Korean Intellectual Property Office, the disclosure of which is incorporated herein in its entirety by reference.

### BACKGROUND OF THE INVENTION

1. Field of the Invention

The present general inventive concept relates to a laser scanning unit (LSU) and an image forming apparatus having the same, and more particularly, to an LSU and an image forming apparatus including a simple laser beam interruption structure to prevent injury to an operator performing maintenance and repair.

2. Description of the Related Art

In general, laser scanning units (LSUs) are employed in laser printers, digital photocopiers, bar code readers, and facsimiles. The LSU forms a latent image by scanning with a beam deflector and sub-scanning through rotation of a photoreceptor.

FIG. 1 illustrates a conventional image forming apparatus 50 disclosed in Korean Patent Publication No. 2004-6350. The image forming apparatus 50 includes a developing unit 10 and an LSU 20 facing each other. The LSU 20 scans a light beam on the developing unit 10 to form a latent image. A laser beam interruption device 30 which forms a boundary between the LSU 20 and the developing unit 10 selectively clears or blocks a transmission opening 20′ of the LSU 20. The light interruption member 30 selectively blocks the transmission opening 20′ of the LSU 20 and includes a protrusion lever 25 that rises and falls inside the LSU 20, inclination sliders 21 guiding the protrusion lever 25 when rising and falling, and an operation unit 15 formed on the developing unit 10 to contact and move the protrusion lever 25. When the developing unit 10 is installed, the operation unit 15 in the upper portion of the developing unit 10 pushes the protrusion lever 25 along the inclination sliders 21 so that an interruption plate 23 coupled to the protrusion lever 25 opens the transmission opening 20′ of the LSU 20. When the developing unit 10 supporting the protrusion lever 25 is removed, the protrusion lever 25 falls downward along the inclination sliders 21 by its own weight and the interruption plate 23 shuts the transmission opening 20′. Accordingly, the image forming apparatus is designed such that the laser beam emitted from the LSU 20 is prevented from draining out to the outside when the developing unit 10 is removed or installed.

According to the conventional image forming apparatus, the operation unit 15 needs to be provided on the developing unit 10 to drive the interruption plate 23 of the LSU 20 to rise and fall. Also, since the transmission opening 20′ is shut only when the developing unit 10 is not installed, the transmission opening 20′ does not prevent the laser beam from escaping to the outside when the developing unit 10 is mounted.

### SUMMARY OF THE INVENTION

The present general inventive concept provides a laser scanning unit (LSU), which has a simplified laser beam interruption structure to reduce manufacturing costs and to simplify the LSU, and an image forming apparatus having the LSU.

The present general inventive concept also provides an LSU in which a laser beam is interrupted when the LSU stops, regardless of whether a developing unit is detached or attached from or to an image forming apparatus.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an LSU including a light source to generate light, a polygon mirror that includes a plurality of reflection mirrors with a polygonal horizontal cross-section to rotate so as to scan the beam from the light source in a main scanning direction, and a light interruption member to swing between a shut position and an open position to selectively block or let pass a light path to the polygon mirror according to whether the polygon mirror is operated or not, wherein the light interruption member is swung to the opening position by an air pressure generated during the operation of the polygon mirror and returns to the shut position by a restoration force when the polygon mirror stops rotating.

The LSU may further include a housing having an area defining an inner space to contain the light source, the polygon mirror, and the light interruption member and a cover member to couple with the housing to seal the inner space. The light interruption member may be connected to an inside area of the cover member to be able to swing.

The light interruption member may also include a coupling unit attached to an inner surface of the cover member, a swing unit to extend vertically from an end of the coupling unit and to be swung by the air pressure induced by the polygon mirror, and a shield unit to extend horizontally from an lateral end of the swing unit to interrupt the light to the polygon mirror.

The light interruption member may also include an elastic body which can be bent according to the air pressure.

An adhesion medium may be disposed between the coupling unit and the cover member to couple the coupling unit to the cover member. The swing unit may be planar and a main surface of the swing unit may be perpendicular to a circumferential direction of the polygon mirror. The shield unit may be planar and the main surface of the swing unit may be perpendicular to the light path between the light source and the polygon mirror.

The light interruption member may return to the shutting position by the light interruption member's elasticity and weight.

The light interruption member may also include a hinge axis rotatably supported on an inside surface of the cover member, a swing unit to extend vertically from the hinge axis to be swung by the air pressure induced by the polygon mirror; and a shield unit to extend horizontally from a lateral end of the swing unit to interrupt the light path to the polygon mirror.

The swing unit may be planar, and a main surface of the swing unit may be perpendicular to the circumferential direction of the polygon mirror.

The shield unit may be planar, and a main surface of the swing unit may be perpendicular to the light path between the light source and the polygon mirror.

The LSU may further include a hinge bracket connected to the inside of the cover member to support the hinge axis to rotate.

The shield unit may extend from one side of the swing unit and may extend asymmetrically from the swing unit. The shield unit may also extend from both sides of the swing unit and may be symmetrical about swing unit.

The foregoing and/or other aspects and utilities of the present general inventive concept may be achieved by providing an image forming apparatus including a laser scanning unit to scan a light signal onto a photoconductive drum to form a latent image, and a developing unit to develop the latent image formed on the photoconductive drum as a visible image on a printing medium, the laser scanning unit including a light source to generate light, a polygon mirror that includes a plurality of reflection mirrors having a polygonal horizontal cross-section to rotate so as to scan the beam from the light source in a main scanning direction, and a light interruption member to swing between a shut position and an open position to selectively block or let pass a light path to the polygon mirror according to whether the polygon mirror is operated or not, wherein the light interruption member is swung to the opening position by an air pressure generated during the operation of the polygon mirror and returns to the shut position by restoration force when the polygon mirror stops.

The foregoing and/or other aspects and utilities of the present general inventive concept may be achieved by providing a laser scanning unit usable in an image forming unit, including a housing, a light source disposed in the housing to generate light, a mirror unit disposed in the housing to direct the light in a direction, and a light blocking member disposed in the housing between the light source and the mirror unit to selectively block the light according to an operation of the mirror unit.

The foregoing and/or other aspects and utilities of the present general inventive concept may be achieved by providing an image forming apparatus, including a developing unit to form a latent image and to develop the latent image with a developing agent, and a laser scanning unit to scan light corresponding to the latent image, the laser scanning unit including a housing, a light source disposed in the housing to generate light, a mirror unit disposed in the housing to direct the light in a direction, and a light blocking member disposed in the housing between the light source and the mirror unit to selectively block the light according to an operation of the mirror unit.

The foregoing and/or other aspects and utilities of the present general inventive concept may be achieved by providing an image forming apparatus, including a light source to generate light in a first direction, a mirror unit to direct the light in a second direction, and a light blocking member to block the light from the light source according to an air pressure generated by an operation of the mirror unit.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates a conventional image forming apparatus;

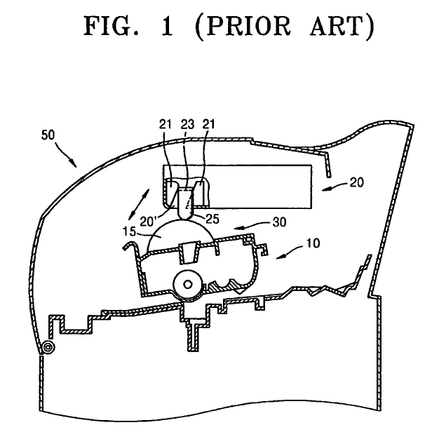

FIG. 2 is illustrates an image forming apparatus according to an embodiment of the present general inventive concept;

FIG. 3 is a perspective view illustrating a laser scanning unit (LSU) of the image forming apparatus of FIG. 2 according to an embodiment of the present general inventive concept;

FIGS. 4 and 5 are perspective views illustrating a light interruption member of the LSU of FIG. 3;

FIG. 6 is a cross-sectional view taken along line VI-VI of FIG. 4 illustrating the operation of the light interruption member;

FIG. 7 is a perspective view illustrating a light interruption member employed in an LSU according to another embodiment of the present general inventive concept; and

FIG. 8 is a perspective view illustrating a light interruption member employed in an LSU according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

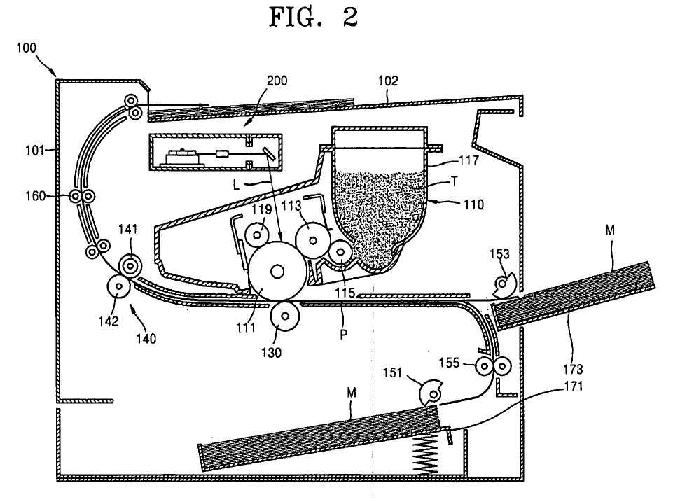

FIG. 2 is illustrates an image forming apparatus 100 according to an embodiment of the present general inventive concept. Referring to FIG. 2, a laser scanning unit (LSU) 200 scans a light signal L into a developing unit 110 and onto a photoconductive drum 111 of the developing unit 110, and forms a latent image on the photoconductive drum 111, charged to a predetermined potential by a charge roller 119. The developing unit 110 includes the photoconductive drum 111 on a circumferential surface of which the latent image is formed by the LSU 200, a developing roller 113 supplying a toner T to the photoconductive drum and developing a toner image on the photoconductive drum 111 corresponding to the latent image, and a supply roller 115 is placed near the developing roller 113 to supply the toner contained in the toner housing 117 to the developing roller 113.

The photoconductive drum 111, on which the toner image is formed, contacts a transfer roller 130 with a predetermined amount of pressure with a printing medium M therebetween. Thus, the toner image on the photoconductive drum 111 is transferred to the printing medium M, which passes between the photoconductive drum 111 and the transfer roller 130, and follows a transfer path P. The printing medium M is piled in a first feeding tray 171 or a second feeding tray 173 and then picked up piece by piece by a first pick-up roller 151 or a second pick-up roller 153, and supplied to the transfer roller 130. A paper aligner 155 is placed between the first pick-up roller 151 and the transfer roller 130. The paper aligner 155 feeds and aligns the printing medium so that the toner image can be transferred to a desired spot of the printing medium M.

A fuser 140 includes a heat roller 141 and a pressure roller 142 closely contacting each other and rotating in opposite directions to each other. As the printing medium M passes through between the heat roller 141 and the pressure roller 142, toner particles that are adhered to the printing medium M are thermally fused by a predetermined amount of heat and pressure. The printing medium M, on which a visible image is fused, passes between a pair of the feeding rollers 160 and released outside a case 101 onto a face-down tray 102.

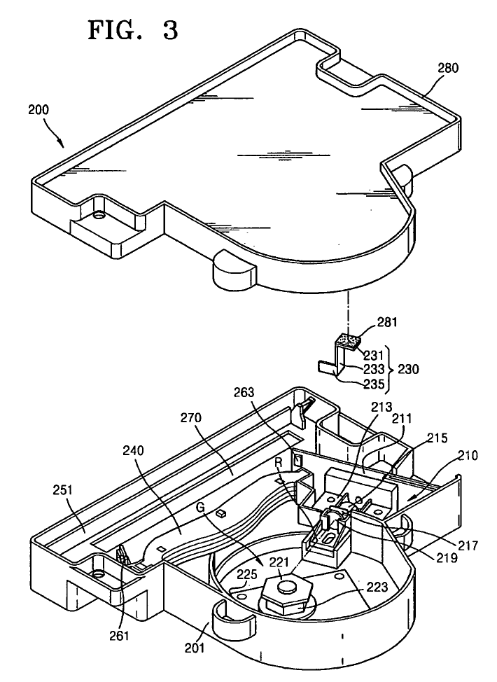

FIG. 3 is a perspective view illustrating the LSU 200. Referring to FIG. 3, the LSU 200 includes a housing 201 and a cover member 280 facing each other and coupled together to provide an inner space G and optical components contained in the inner space G. The housing 201 contains a scanning optical system scanning a light beam on the photoconductive drum 111 to form a linear latent image, and shields the optical components from external conditions. In general, the housing 201 may be manufactured by injection molding, but its manufacturing method is not limited thereto. An upper portion of the housing 201 is closed by the cover member 280 formed to correspond to the housing 201, which seals the inner space G. According to the present embodiment of the general inventive concept, a light interruption member 230 is placed at a predetermined position inside the cover member 280, which will be described in detail later.

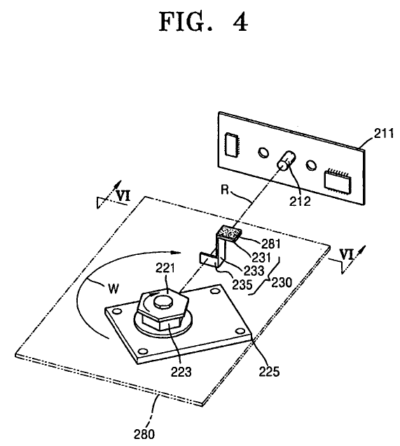

A light source unit 210 is placed at a side of the housing 201 to provide a regularly shaped light beam. The light source unit 210 includes a holder guide 213 in which a lens holder 215 is mounted and a circuit substrate 211 which is combined on the back of the holder guide 213. An aperture 217 and a cylindrical lens 219 are sequentially disposed in the front of the holder guide 213. A light emitting device (212 of FIG. 4) that emits the light beam is mounted onto the light emitting circuit substrate 211. The light emitting device 212 may be a light emitting diode (LED) or a laser diode (LD). The light beam emitted from the light emitting device is incident on a side of the lens holder 215 mounted on the holder guide 213. The lens holder 215 is approximately a hollow cylinder, in which a collimating lens (not shown) is fixed. The collimating lens collimates a divergent light emitted from the light emitting device into a parallel light.

The parallel light collimated by the collimating lens passes through the aperture 217 disposed along the light path and is shaped into a wide light beam in a main scanning direction. Then the parallel light passes through the cylindrical lens 219 disposed next to the aperture 217 and is converged in a sub-scanning direction and focused on a polygon mirror 221, which will be described later. The main scanning direction indicates the direction in which the light beam is scanned on the photoconductive drum 111 by the polygon mirror 221, and the sub-scanning direction indicates a rotation direction of the photoconductive drum 111.

A second circuit substrate 225 on which the polygon mirror 221 is mounted is placed in a predetermined area of the housing 201 facing the light source unit 210. The polygon mirror 221 has a plurality of reflection surfaces, and is installed on a rotor of a driving motor 223 to be rotated at a high speed. The light beam incident on the polygon mirror 221 is reflected by the reflection surfaces rotating at the high speed. The light beam is deflected and scanned in the main scanning direction and passes through a scanning optical lens 240, also called an f-θ lens, to be focused with different magnifications in the main scanning direction. Accordingly, an incident light is focused on the photoconductive drum 111 to form the linear latent image. To this end, the shape of the scanning optical lens 240 varies along the main scanning direction. The light beam focused by the scanning optical lens 240 is reflected by a reflection mirror 251 toward the photoconductive drum 111. An approximately rectangular window 270 is provided on the lower surface of the housing 201. The light beam is emitted through the window 270 and scanned onto the photoconductive drum 111 outside the LSU 200. Further, a synchronization mirror 261 and a light sensor 263, which receives the light beam reflected by the synchronization mirror 261, may be placed between the scanning optical lens 240 and the reflection mirror 251.

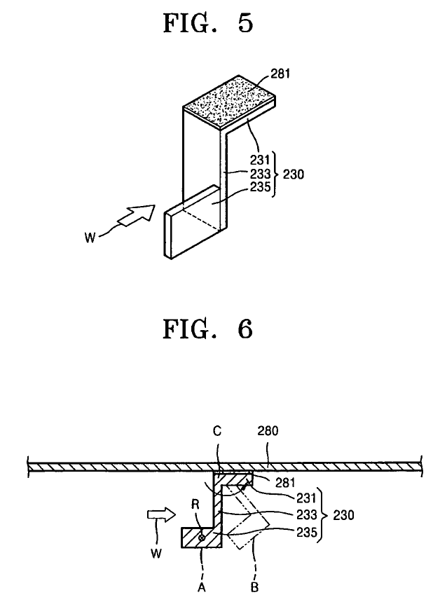

When the cover member 280 is coupled onto a top of the housing 201, the light interruption member 230 attached to a lower surface of the cover member 280 by an adhering medium 281 is placed on a light path R between the light source unit 210 and the polygon mirror 221. FIGS. 4 and 5 are perspective views illustrating the light interruption member 230 of FIG. 3. Referring to FIG. 4, the light interruption member 230 is attached to the lower surface of the cover member 280 at a predetermined position along the light path R to clear or obstruct the light path R according to an operation of the polygon mirror 221, and thus prevents the light beam from flowing out in case of an emergency. In an embodiment of the present general inventive concept, the light interruption member 230 is a bent plate. The light interruption member 230 may include a coupling unit 231 attached to the lower surface of the cover member 280, a swing unit 233 bent from the coupling unit 231 and to extend vertically from the lower surface of the coupling unit 281, and a shield unit 235 to extend horizontally from an end of the swing unit 233. A main surface of the swing unit 233 is perpendicular to a circumference of the polygon mirror 221. The main surface of the swing unit 233 may be parallel to light path R. The swing unit 233 swings along a circumference direction of the polygon mirror 21 due to a circular air flow W about a rotational axis of the polygon mirror 221. The shield unit 235 is placed on the light path R between the light emitting device 212 and the polygon mirror 221 and selectively clears or obstructs the light path R. The light interruption member 230 may be made of an elastic material such that it can swing between an open position B (FIG. 6) and a shut position A (FIG. 6) through elastic deformation and restoration to its natural state. The elastic material constituting the light interruption member 230 may be selected in consideration of an air pressure generated during the operation of the polygon mirror 221 and the area of the swing unit 233, and an elastic modulus can be given for the standards for selection.

FIG. 6 is a cross-sectional view taken along line VI-VI of FIG. 4 illustrating an operation of the light interruption member 230. When the laser scanning unit 200 is driven, the airflow W is generated along the circumference of the polygon mirror 221 rotating at the high speed, and the airflow W pushes the swing unit 233 of the light interruption member 230 and swings the light interruption member 230 from the shut position A to the open position B. The swing unit has a surface having a width to receive a force of the airflow. The light interruption member 230 returns to the shutting point B by its own elasticity, and can swing about an axis C, which forms a boundary between the coupling unit 231 and the swing unit 233. That is, when the polygon mirror 221 does not rotate, the airflow W is not generated so that the force of the airflow on swing unit 233 is removed. When the light path R, which connects the light emitting device 212 and the polygon mirror 221, is opened by removing the shield unit 233 from the light path R by the light interruption member 230 being moved to the open position B, the light beam emitted from the light emitting device 212 is incident on the rotating polygon mirror 221 and is scanned onto the photoconductive drum 111 to form the latent image. The swing unit 233 may have an angle with the shield unit 235 so that the shield unit 335 moves in a direction having an angle with the light path R, and the swing unit 233 is disposed in a direction to receive the force.

The light interruption member 230 returns to an erect posture in the shut position A by light interruption member's own elasticity and weight when the polygon mirror 221 stops operating, and obstructs the light path R between the light emitting device 212 and the polygon mirror 221. That is, as the polygon mirror 221 stops rotating, the airflow W around the polygon mirror 221 stops, and the light interruption member 230 is moved to the shutting point A by its own elasticity and weight. Since the light interruption member 230 selectively clears and obstructs the light path according to whether the polygon mirror 221 is operated or not, an injury due to exposure to a laser beam when the developing unit 110 is attached or detached for maintenance and repair of the image forming apparatus is prevented. In particular, in the present embodiment of the general inventive concept, the laser beam is interrupted when the polygon mirror 221 stops, and thus higher safety standards can be achieved compared to the prior art in which a laser beam is interrupted only when the developing unit 110 is removed. Further, since the beam interruption structure is simplified compared to the prior art, manufacturing costs are reduced and the entire image forming apparatus can be simplified. The swing unit 233 and the shield unit 235 may be formed in a monolithic body.

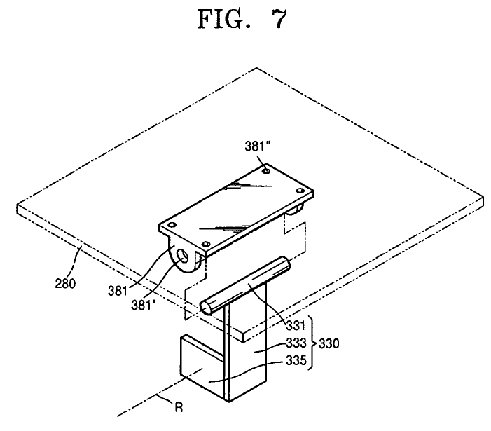

FIG. 7 is a perspective view illustrating a light interruption member 330 employed in an LSU according to another embodiment of the present general inventive concept. Referring to FIG. 7, the light interruption member 330 includes a hinge axis 331, a swing unit 333 vertically extending downward from the hinge axis 331, and a shield unit 335 horizontally extending from an end of the swing unit 333. The hinge axis 331 is rotatably supported on the cover member 280 and the light interruption member 330 rotates around the hinge axis 331. A hinge bracket 381 is coupled onto an inside surface of the cover member 280. A screw hole 381″ is formed in the hinge bracket 381, and a screw member (not shown) passes through the screw hole 381″ and is coupled to the cover member 280. The hinge axis 331 is inserted in hinge holes 381′ formed in the hinge bracket 381 to be rotatable. The light interruption member 330 of the present embodiment pivots around the hinge axis 331 in the cover member, and thus can be a rigid body instead of an elastic body. Also, elastic deformation is not required during the operation of the light interruption member, and thus the light interruption member 330 can operate smoothly even when the air pressure generated by the polygon mirror is relatively low.

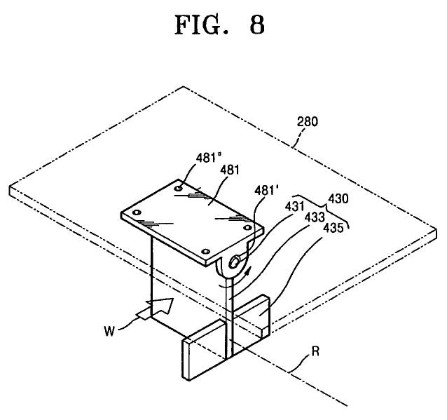

FIG. 8 is a perspective view illustrating a light interruption member 430 employed in the LSU 200 according to another embodiment of the present general inventive concept. The light interruption member 430 includes a hinge axis 431, a swing unit 433 vertically extending from the hinge axis 431 downward, and a shield unit 435 horizontally extending from an end of the swing unit 433. A hinge bracket 481 is coupled onto the inside surface of the cover member 280. A screw hole 481″ is formed in the hinge bracket 481, and a screw member (not shown) passes through the screw hole 481″ and is coupled to the cover member 280. The hinge axis 431 is inserted in hinge holes 481′ formed in the hinge bracket 481 to be rotatable. Since the shield unit 435 in the present embodiment of general inventive concept is extended symmetrically about the swing unit 433, when the polygon mirror 221 stops operating, the light interruption member 430 falls to a vertical position in which it is balanced due to its symmetry, and interrupts the light path R. The light path R intersects the center of the light interruption member 430, and a sufficient margin is secured to align the light interruption member 430 with the light path R which connects the light emitting device 212 and the polygon mirror 221. Therefore, precise alignment of the light interruption member 430 is not required, and thus alignment can be easier.

The laser scanning unit and the image forming apparatus of the present general inventive concept includes a light interruption member which selectively interrupts a laser beam according to an operation of a polygon mirror to prevent an injury to the user due to exposure to the laser beam when the polygon mirror stops operating. In particular, since the laser beam is interrupted when the polygon mirror is stopped, higher safety standards are satisfied compared to the prior art, in which the laser beam is interrupted only when the developing unit is removed. Further, a structure of the laser beam interruption member is simple, thus reducing the manufacturing costs and simplifying an entire image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A laser scanning unit (LSU) comprising:
a light source to generate light;
a polygon mirror that comprises a plurality of reflection mirrors with a polygonal horizontal cross-section to rotate so as to scan the beam from the light source in a main scanning direction; and
a light interruption member to swing between a shut position and an open position to selectively block or let pass a light path to the polygon mirror according to whether the polygon mirror is operated or not,
wherein the light interruption member is swung to the opening position by an air pressure generated during the operation of the polygon mirror and returns to the shut position by a restoration force when the polygon mirror stops rotating.

2. The LSU of claim 1, further comprising:
a housing comprising an area defining an inner space to contain the light source, the polygon mirror, and the light interruption member, and
a cover member to couple with the housing to seal the inner space.

3. The LSU of claim 2, wherein the light interruption member is connected to an inside area of the cover member to be able to swing.

4. The LSU of claim 2, wherein the light interruption member comprises:
a coupling unit attached to an inner surface of the cover member;
a swing unit to extend vertically from an end of the coupling unit and to be swung by the air pressure induced by the polygon mirror; and
a shield unit to extend horizontally from an lateral end of the swing unit to interrupt the light to the polygon mirror.

5. The LSU of claim 4, wherein the light interruption member comprises an elastic body which can be bent according to the air pressure.

6. The LSU of claim 4, wherein the shield unit is planar and a main surface of the swing unit is perpendicular to the light path between the light source and the polygon mirror.

7. The LSU of claim 4, wherein the light interruption member returns to the shutting position by the light interruption member's elasticity and weight.

8. The LSU of claim 2, wherein the light interruption member comprises:
a hinge axis rotatably supported on an inside surface of the cover member;
a swing unit to extend vertically from the hinge axis to be swung by the air pressure induced by the polygon mirror; and
a shield unit to extend horizontally from a lateral end of the swing unit to interrupt the light path to the polygon mirror.

9. The LSU of claim 8, wherein the shield unit is planar, and a main surface of the swing unit is perpendicular to the light path between the light source and the polygon mirror.

10. The LSU of claim 8, further comprising a hinge bracket connected to an inside area of the cover member to support the hinge axis to rotate.

11. The LSU of claim 8, wherein the shield unit extends from one side of the swing unit and extends asymmetrically from the swing unit.

12. The LSU of claim 8, wherein the shield unit extends from both sides of the swing unit and is symmetrical about the swing unit.

13. The LSU of claim 8, wherein the light interruption member returns to the shutting position by its own weight.

14. An image forming apparatus comprising:
a laser scanning unit to scan a light signal onto a photoconductive drum to form a latent image; and
a developing unit to develop the latent image formed on the photoconductive drum as a visible image on a printing medium, the laser scanning unit comprising:
a light source to generate light,
a polygon mirror that comprises a plurality of reflection mirrors having a polygonal horizontal cross-section to rotate so as to scan the beam from the light source in a main scanning direction, and
a light interruption member to swing between a shut position and an open position to selectively block or let pass a light path to the polygon mirror according to whether the polygon mirror is operated or not,
wherein the light interruption member is swung to the opening position by an air pressure generated during the operation of the polygon mirror and returns to the shut position by restoration force when the polygon mirror stops.

15. The image forming apparatus of claim 14, further comprising:
a housing having an area to define an inner space to contain the light source, the polygon mirror, and the light interruption member; and
a cover member to couple with the housing to seal the inner space,
wherein the light interruption member is connected to the inside of the cover member to be able to swing.

16. The image forming apparatus of claim 14, wherein the light interruption member comprises:
a coupling unit attached to an inner surface of the cover member;
a swing unit to extend vertically from an end of the coupling unit to be swung by the air flow induced by the polygon mirror; and
a shield unit to extend horizontally from a lateral end of the swing unit to interrupt the light to the polygon mirror.

17. The image forming apparatus of claim 14, wherein the light interruption member comprises:
a hinge axis rotatably supported on an inside surface of the cover member;
a swing unit to extend vertically from the hinge axis to be swung by the air pressure induced by the polygon mirror; and
a shield unit to extend horizontally from a lateral end of the swing unit to interrupt the light path to the polygon mirror.

18. A laser scanning unit usable in an image forming unit, comprising:
a housing;
a light source disposed in the housing to generate light;
a mirror unit disposed in the housing to direct the light in a direction; and
a light blocking member disposed in the housing between the light source and the mirror unit to selectively block the light according to an operation of the mirror unit.

19. The laser scanning unit of claim 18, wherein the light blocking member moves between a first position to block the light and a second position to allow the light to pass according to a movement of the mirror unit.

20. The last scanning unit of claim 18, wherein the light blocking member blocks the light according to an airflow generated by a movement of the mirror unit.

21. An image forming apparatus, comprising:
a developing unit to form a latent image and to develop the latent image with a developing agent; and
a laser scanning unit to scan light corresponding to the latent image, the laser scanning unit comprising:
a housing;
a light source disposed in the housing to generate light;
a mirror unit disposed in the housing to direct the light in a direction; and
a light blocking member disposed in the housing between the light source and the mirror unit to selectively block the light according to an operation of the mirror unit.

22. An image forming apparatus, comprising:
a light source to generate light in a first direction;
a mirror unit to direct the light in a second direction; and
a light blocking member to block the light from the light source according to an air pressure generated by an operation of the mirror unit.

23. The image forming apparatus of claim 22, wherein the light blocking member comprises a swing unit having a first surface in a third direction to receive the air pressure of an air flow, and a shield unit having a second surface extended from the first surface in a fourth direction to block or open a light path of the light.

24. The image forming apparatus of claim 23, wherein the shield unit moves in a fifth direction different from the first direction according to a movement of the swing unit.
